(19) United States
(12) Patent Application Publication
(10) Pub. No.: US 2012/0256906 A1
(43) Pub. Date: Oct. 11, 2012

(54) SYSTEM AND METHOD TO RENDER 3D IMAGES FROM A 2D SOURCE

(75) Inventors: Kevin Ross, Sunnyvale, CA (US); Robertus Vogelaar, Morgan Hill, CA (US); Om Prakash Gangwal, Sunnyvale, CA (US); Johan Janssen, Sunnyvale, CA (US); Haiyan He, Saratoga, CA (US); Wim Michiels, San Jose, CA (US); Erwin Bellers, Sunnyvale, CA (US)

(73) Assignee: TRIDENT MICROSYSTEMS (FAR EAST) LTD., GRAND CAYMAN (KY)

(21) Appl. No.: 13/250,895

(22) Filed: Sep. 30, 2011

Related U.S. Application Data
(60) Provisional application No. 61/388,549, filed on Sep. 30, 2010.
(60) Provisional application No. 61/409,835, filed on Nov. 3, 2010.

(51) Int. Cl. G06T 15/04

(52) U.S. Cl. 345/419

(57) ABSTRACT

A system and method to render 3D images from a 2D source are described. An embodiment of a method to render 3D images from a 2D source comprises the steps of providing a graphics rendering device to estimate depth of a 2D image; providing video or graphics textures and depth-maps to describe an object in a 3D scene; creating, in one embodiment, a single view angle and in another preferred embodiment at least two view angles of the 3D scene to represent an intraocular distance using the graphics rendering device; and presenting both of the at least two view angles on a display using the graphics rendering device and especially the commonly available 3D imaging technology of the graphics rendering device.

### PRIORITY CLAIM/RELATED APPLICATIONS

This application claims the benefit under 35 USC 119(e) and priority under 35 USC 120 to U.S. Provisional patent application Ser. No. 61/388,549 filed on Sep. 30, 2010 and entitled “A system and method to render 3d images from a 2d source” and to U.S. Provisional patent application Ser. No. 61/409,835 filed on Nov. 3, 2010 and entitled “A system and method to render 3d images from a 2d source”, the entirety of both of which are incorporated herein by reference.

### FIELD

The disclosure is related to a method to render 3D images from a 2D source. In particular, the disclosure is related to a method providing graphics components to assist with rendering 3D images from a 2D source. The disclosure is also related to a method providing graphics components to assist with rendering and optionally computation of 3D images from a 2D source. The disclosure further relates to a communications system to render 3D images from a 2D content delivery source. The disclosure also relates to a method of customization of a display.

### BACKGROUND

Many algorithms exist for estimating depth of a 2D image which is used for a 2D-to-3D conversion. The depth map may be available at the frame-rate or less, and may be provided per-pixel or per group of pixels. After having generated the depth-map it is used as input to a 3D rendering engine. That rendering is also proprietary and runs on separate and dedicated hardware. Conceptually, that rendering maps the entire 2D image to a set of triangles and then performs a transformation (stretching or shrinking the triangle dimensions with pixel dropping, repeating of some interpolation/decimation algorithm) to create a second view (original plus new) or to create two views (derived from the original) to represent an intraocular distance for two view angles on the scene. Those views form the 3D interpretation.

In current graphics systems a proprietary hardware is generally used for the 2D to 3D transformation. This concept is cost extensive. Furthermore, programming routines which are still available on legacy platforms has especially to be implemented for the hardware components used for the 2D-to-3D transformations.

Accordingly, there has been a demand to use commonly available hardware of a graphics system to perform a 2D-to-3D transformation.

### BRIEF DESCRIPTION OF THE DRAWINGS

FIG. 1 is a schematic of a 2D-to-3D conversion.

FIG. 2 shows a graphics system coupled to a display.

FIG. 3 illustrates an embodiment of a method to render 3D images from a 2D source in a block diagram.

FIG. 4 illustrates an embodiment of a method to render 3D images from a 2D source in a block diagram.

FIG. 5 shows an Open GL ES pipeline.

FIG. 6 shows a communications system for transferring data between devices.

### DETAILED DESCRIPTION OF ONE OR MORE EMBODIMENTS

An embodiment of a method to render 3D images from a 2D source comprises the steps of providing a graphics rendering device to estimate depth of a 2D image; providing video textures or graphic images and depth-maps to describe an object in a 3D scene; creating at least two view angles on the 3D scene to represent an intraocular distance using the graphics rendering device; and presenting both of the at least two view angles on a display using the graphics rendering device and especially the commonly available 3D imaging technology of the graphics rendering device.

The graphics rendering device may be provided with a separately calculated depth-map. The depth-map may be calculated by a DSP and may be passed to the graphics rendering device as a depth texture. The depth-map may be determined by the use of cell phones or PCs, where the depth map may be calculated in the commonly available hardware. The depth-map may also been calculated within the graphics core.

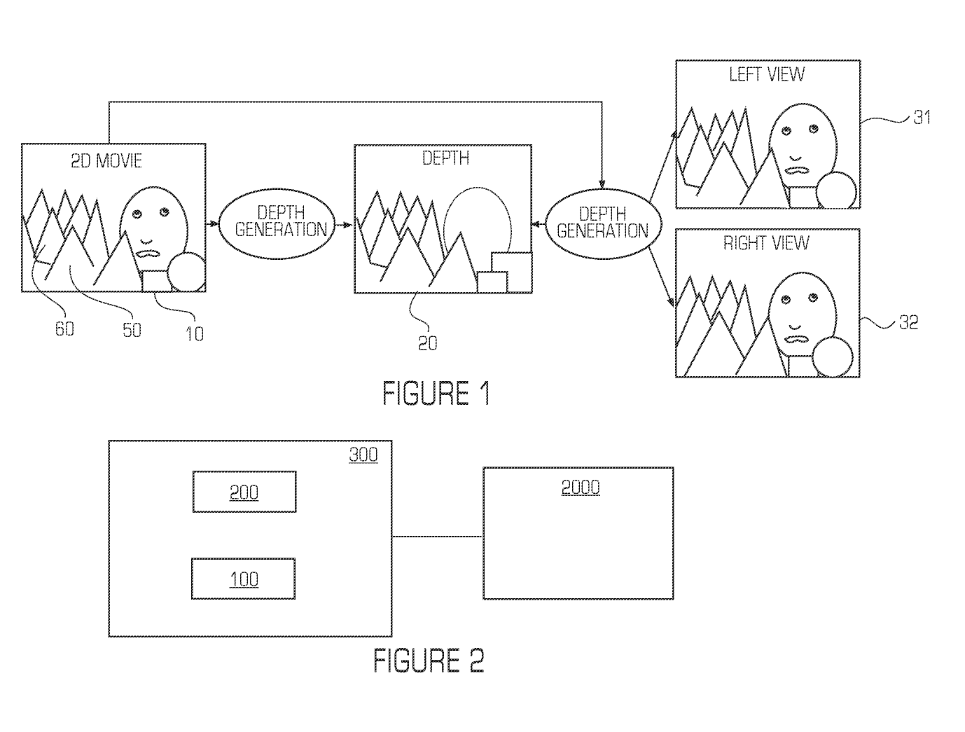

The conversion of legacy 2D content to 3D is required in many applications such as in the 3DTV technology. FIG. 1 illustrates processing steps of a 2D-to-3D conversion. This process consists of two steps. The first step is the depth generation from 2D image/video 10, and the second step is the generation of left and right shifted views 31, 32 from the original 2D image 10 and a generated depth-map 20. FIG. 1 shows the depth-map 20 in which low gray values are behind and high gray values are in front in the depth-map.

Rather than providing proprietary hardware for the 2D-to-3D transformation, commonly available hardware is used to perform the 2D-to-3D transformation. FIG. 2 shows a graphics system 300 to render an image on a display 2000 which is connected to the graphics system. The graphics system comprises a graphics rendering device 100 and a graphics core 200. The conversion of a 2D image to a 3D image is performed by the graphics rendering device 100 outside of the graphics core.

The 3D model is generated in the graphics core and two view-angles are projected/calculated. Those two views are then presented to the display. Basically, a 3D object is defined by the vertex locations and their depths. The video texture is used as the ‘skin’ to cover this 3D object. The rendering of the 3D model is then calculated from two angles all done within the graphics core. The two resulting images are then sent to the display to be rendered on a screen.

The graphics rendering device 100 is a commonly available hardware of the graphics system, such as a DSP or a 3D graphics core. The conversion algorithm may equally be performed on a standard processor on the platform.

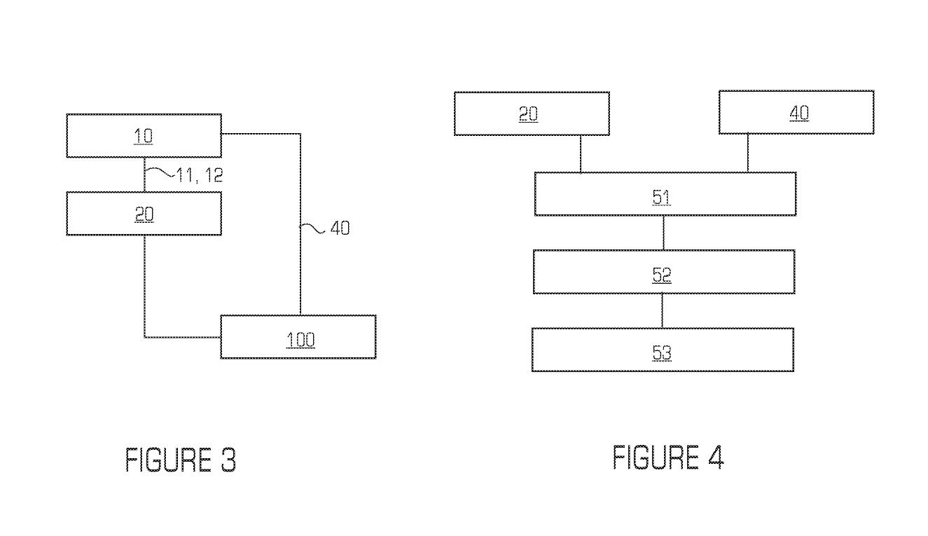

FIG. 3 shows an embodiment of the algorithm to convert a 2D image in a 3D image performed by the graphics rendering device 100. A depth-map may be generated from the 2D image. Various techniques can be used to form the depth-map from the 2D image.

In a possible embodiment, the depth-map 20 is calculated using a scaled image 10 using chroma-information 11 only and using contrast information 12 to determine likely depth. This is done outside of the graphics core on existing system resources, such as a DSP. The generation of the depth-map may equally be done on a standard processor on the platform. The result is a depth-map 20 which is an array of depths at a resolution at a given frame-rate related to the source content.

In parallel, the 2D content itself is used as a texture 40. The 3D-capable graphics engine, i.e. the graphics rendering device 100, takes the (e.g. video) texture 40 and applies this to a surface with the aforementioned depth-map.

FIG. 4 shows the generation of a 3D image on the display 2000 by the graphics system 300 using the graphics rendering device 100 which is a commonly available hardware component of the graphics system. In a step S1 the 3D-capable graphics engine 100 takes the texture 40 and applies this to a surface with the aforementioned depth-map 20, actually to a 3D object, that has a set of vertices defined by a fixed grid in the X-Y direction and varying depth (Z-direction) defined by the depth-map. Effectively, the view of this image normal to the object is identical to the 2D image, but a slightly offset view-angle would yield a second image that would be distorted based on the depth-map and view angle.

In a preferred embodiment, two view angles are used that are both offset to the normal. The different view angles are created on the scene to represent an intraocular distance in a step S2. This technique ensures that vertical straight lines remain straight. In a step S3, both of the view angles are presented to a viewer on the display 2000 using commonly available 3D imaging technology implemented in the graphics rendering device. On a less powerful 3D graphics processing device, one view angle can be calculated in a graphics devices and the second view angle is the original image. This introduces some distortion or artifacts but enables frame rate to be twice as high. The artifacts can be minimized by providing a accurate depth mapping from source or by an improved depth estimation algorithm. Alternatively, or in addition, the interoccular distance can be minimized of the second graphical rendering to reduce artifacts.

It should be noted that the surface is simply a 3D object with a texture and a depth-map. All manipulations on the object, e.g. page turn, applying the surface to an object e.g. cylinder or otherwise, i.e. by redefining the shape of the 3D object by moving the vertices would yield expected results for 3D graphics manipulation. The object may be manipulated as per any 3D texture. A vertex shader may be used to move vertices in a 3D space to mimic a page turn. The shape of the 3D object is changed by a zoom, rotate or morph operation. The vertices moved and the fragment shader fills in the same triangle's worth of image on the same vertex points.

If other objects were placed in the scene, e.g. a menu item, then if one object 50 occludes another object 60, as shown in FIG. 1, then the graphics engine would simply cull and draw as appropriate taking into consideration the objects' opacity. The video may be translucent—e.g. in the case of video in a window on a window manager or desktop.

This further introduces capability that cannot be achieved on legacy technology, as today's embodiments manipulate the final image thereby not addressing occlusion or transparency that would have to be solved with some other techniques.

FIG. 6 shows a communications system for transferring data between devices. A data delivery source 3000, e.g. a cable head end, provides data to a receiver 1000 which may be configured as a set top box. The set top box 1000 is coupled to the display 2000. The method enables to render 2D content as delivered from the content delivery source on the display using the described graphics engine, e.g. a standard processor on the platform, to perform the rendering. The 3D rendering capability at the set to box may also be used to implement display customization. The method is independent on 3D rendering, and applicable once a 3D object is available, e.g. on a 2D-only render. Metatdata are received in the received transport stream or otherwise than maps one object in the scene.

The downloadable texture may be used to overlay a current object in the scene. The set top box or the graphics rendering device is configured to blend a texture in an area of the image as provided from the content delivery source. Thus, the original content of an image which is delivered by the content delivery source 3000 may be added by add-ons. The add-ons are provided by the graphics rendering device or the set top box. As an example, the method enables to replace a logo of a firm originally included in the image delivered by the content delivery source with a logo of another firm provided by the set top box. As another example, the graphics rendering device may render an image including a label wrapped about an object in the scene, wherein the object was originally transmitted from the content delivery source to the graphics rendering device with a different label. Thus, the 3D rendering capability at the set top box (1000) may be used to implement a customization of the content of an image displayed of the display of a viewer.

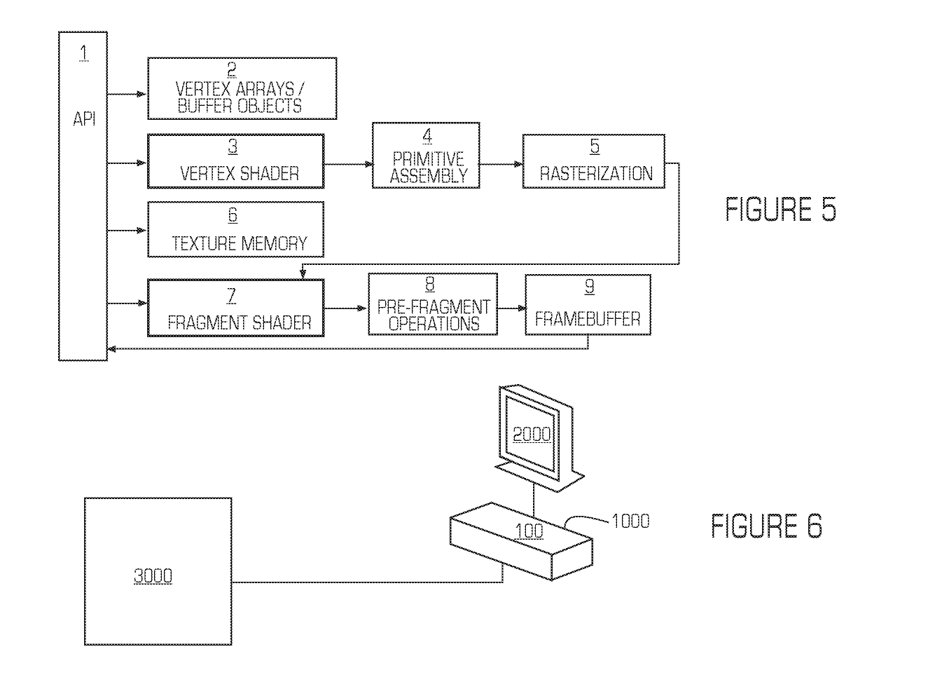

The algorithm to convert a 2D image to a 3D image may be performed by the graphics rendering device 100 using a common programming language. OpenGL (Open Graphics Library) or OpenGL-ES (Open Graphics for Embedded Systems) may be used as preferred programming language. FIG. 5 shows an Open GL ES 2.0 graphics pipeline. The pipelines is composed of an API 1 coupled to Vertex Arrays/Buffer Objects 2, a vertex shader 3, a texture memory 6 and a fragment shader 7. FIG. 5 also shows a primitive assembly 4, a rasterization 5, Per-Fragment operations 8 and a frame buffer 9 as further components of the Open GL ES Graphics pipeline.

The use of commonly available hardware, such as the graphics rendering device or the graphics engine, enables to reduce cost and further enables feature introduction on legacy platforms. The concept also enables additional capabilities and use-cases that are typically provided by that commonly available hardware. A 3D object , i.e. the image and the depth-map, may be used as part of a resource for rendering use-cases—e.g. as part of a game, e.g. the crowd or the background in general.

1. A method to render 3D images from a 2D image source, comprising:
providing a depth map and a 2D image;
creating at least two view angles on each 3D scene to represent an intraocular distance using a graphics rendering device; and
presenting both of at least two view angles on a display using the graphics rendering device for at least one of two view angles.

2. The method of claim 1 where at least one of the view angles is normal to the original image and the other view angle is offset.

3. A method to render 3D images from a 2D image source, comprising:
providing textures and depth-maps to describe an object in a 3D scene;
creating an offset view angle on the 3D scene to represent an intraocular distance using a graphics rendering device;
presenting at least two view angles on a display using the graphics rendering device wherein one of the view angles is normal to the original and the other is the offset view angle that visually introduces horizontal tilt.

4. The method of claim 3 wherein the provided texture is one of a graphics texture and a video texture.

5. The method of claim 3, wherein the original image is provided for viewing by one eye of a viewer and the 3D core provides a second rendered image for viewing by the other eye of the viewer wherein the amount of work for the 3D core is halved and the effective frame-rate is increased.

6. The method of claim 3 wherein the frame rate is increased by at least a factor of two.

7. A method to render 3D images from a 2D source, comprising:
providing a graphics rendering device (100) to estimate depth of a 2D image;
providing video textures (40) and depth-maps (20) to describe an object (50) in a 3D scene;
creating at least two view angles on the 3D scene to represent an intraocular distance using the graphics rendering device; and
presenting both of the at lest two view angles on a display using the graphics rendering device.

8. The method as claimed in claim 7 wherein the graphics rendering device is one of compliant to a programming language and compliant to OpenGL or OpenGLES.

9. A method to render a 3D image from a 2D source, comprising:
providing a graphics rendering device to generate a depth-map of a 2D image;
providing video textures to describe an object in a 3D scene,
calculating a depth-map of a graphics system in the 3D scene within a graphics core to describe the object;
creating at least two view angles on the scene to represent an intraocular distance;
presenting both view angles on a display using the graphics rendering device.

10. The method as claimed in claim 9, wherein the graphics rendering device is one of compliant to a programming language and compliant to OpenGL or OpenGLES.

11. The method of claim 7, comprising:
rendering another object in the 3D scene by using draw capabilities of the graphics rendering device to represent at least one of occlusion and transparency of the objects.

12. The method as claimed in claim 7, comprising:
rendering optional transparency settings on the video texture.

13. The method as claimed in claim 7, comprising:
providing the transparency settings on the video texture per pixel, gradation, or fixed.

14. The method as claimed in claim 7, comprising:
manipulating the object as per any 3D texture.

15. The method as claimed in claim 7, comprising:
using a vertex shader to move vertices in a 3D space to mimic a page turn;
changing the shape of the 3D object; and
applying the texture to the 3D object.

16. The method of claim 7, wherein the step of rendering the transparency settings is performed on a window-manager, wherein part of object is occluded or partial transparency depending on which window in total display is active.

17. The method as claimed in claim 7, wherein the 2D image and the depth-map is used as part of a resource for rendering scenes.

18. A communications system, comprising:
a graphics rendering device;
a display;
said graphics rendering device is configured to render 2D content as delivered from a content delivery source on said display.

19. The communications system as claimed in claim 18, wherein said graphics rendering device is a processor included in a set top box.

20. A method of providing a display customization, comprising:
using a 3D rendering capability at a set top box to implement a customization of a display.
